(19) United States
(12) Patent Application Publication
(10) Pub. No.: US 2010/0056188 A1
(43) Pub. Date: Mar. 4, 2010

(54) Method and Apparatus for Processing a Digital Image to Select Message Recipients in a Communication Device

(75) Inventor: Boaz J. Super, Westchester, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/201,142

(22) Filed: Aug. 29, 2008

(51) Int. Cl. H04Q 7/20

(52) U.S. Cl. 455/466

(57) ABSTRACT

There is disclosed a communication device for processing a digital image to select recipients for the digital image or a modified digital image. The communication device comprises an input device, a processor, and a transmitter. The input device obtains the digital image, and receives an indication based on a user input that pertains to a region on the digital image. The processor processes the indicated region of the digital image, and determines an object corresponding to one or more recipients of the digital image. The transmitter transmits a message that includes the digital image or a modified digital image to the recipient corresponding to the determined object.

### FIELD OF THE DISCLOSURE

The present disclosure relates generally to digital image processing and more specifically to a method and an apparatus for processing a digital image to select the recipients for the digital image in a communication device.

### BACKGROUND

Digital image and video technology promises to enhance our use of photographs and video by making them easy to store, access, and share. Sharing digital images using a communication system has become a very popular activity. One model of image sharing is through the use of online image sharing websites. To share images on these websites, a user uploads copies of his or her images to the hosting server, and the user's friends and family can view them by downloading them to their own computer or by viewing them while still resident on the server. Another model is through peer-to-peer sharing where short range wireless communication systems are used to transfer images from one user to another user. In another model, a digital image may be sent electronically as an email attachment to a recipient having a computer, a mobile phone, or other communication device. In this model, the user typically selects the recipient by accessing a list of contacts and indicating that the digital image be sent as an email attachment to the recipient. These user commands are typically performed using scrolling actions, menu item selections, and button pushes found in widely-used user interfaces. It is desirable to provide a method whereby the user indicates that the image is to be shared with the recipient without much user interaction.

For a few image sharing models, face recognition software is used to recognize the recipients of the digital image. Face recognition software, in this case, has to perform a complete scanning of the digital image to identify potential recipients for the digital image. The complete scanning of the digital image by the face recognition software is inefficient. Complete scanning of the digital image may miss some faces and/or produce some false results. Complete scanning may also identify faces belonging to people that the user does not want to send the digital image to.

Accordingly, there is a need for an improved and more efficient method and apparatus for processing a digital image to select recipients for the digital image in a communication device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1(A), 1(B) and 1(C) are diagrams illustrating a communication device in accordance with some embodiments.

FIG. 2 is a flow diagram of an operation of a communication device in accordance with some embodiments.

FIG. 3 is a flow diagram of an operation of a communication device in accordance with some embodiments.

FIG. 4 is a flow diagram of an operation of a communication device in accordance with some embodiments.

FIG. 5 is a block diagram of a communication device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to various embodiments, a method for processing a digital image to select recipients for the digital image in a communication device includes obtaining the digital image. The method further includes receiving an indication based on a user input, the indication pertaining to a region on the digital image, and processing the indicated region of the digital image to determine an object corresponding to at least one recipient of the digital image. The method then includes transmitting a message to the recipient corresponding to the determined object, wherein the message includes the digital image or a modified digital image.

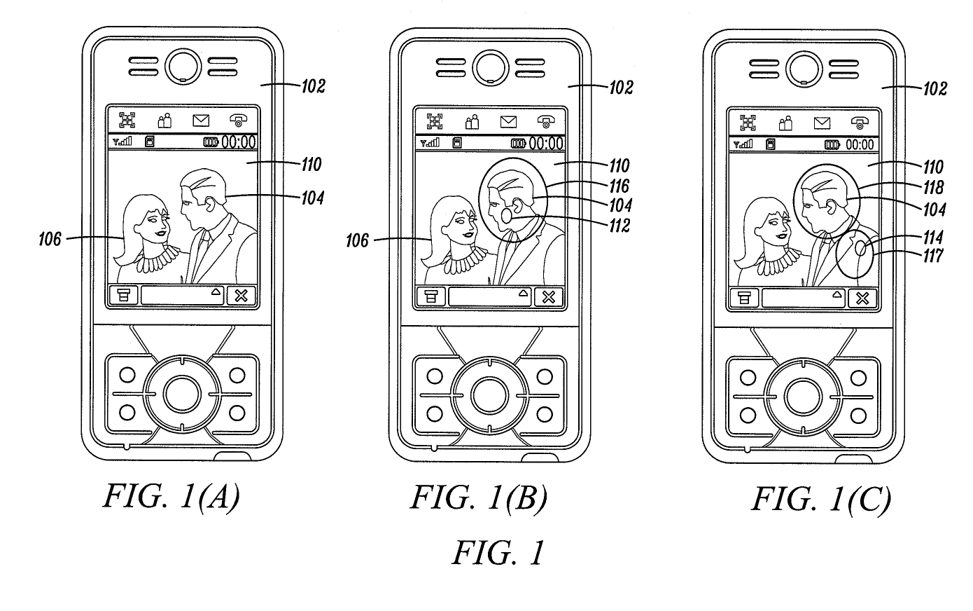

Referring now to figures, FIGS. 1(A), 1(B) and 1(c) illustrate a communication device 102 in accordance with some embodiments. The communication device 102 is configured for face recognition in the digital image, selection of recipients for the digital image, and transmission of the digital image or a modified digital image to the selected recipients. As shown, FIG. 1(A) illustrates the communication device 102 with a digital image 110. The digital image 110 may include, for example, a first human 106 and a second human 104. In one example, the digital image may be obtained from a digital camera, internal or external, coupled to the communication device 102. FIGS. 1(B) and 1(c) also include the digital image 110 with selections 112 and 114 made on the digital image 110 by a user of the communication device 102.

The communication device 102 includes the capability to communicate with a network node through one or more wireless communication protocols such as Advanced Mobile Phone System (AMPS), Code division multiple access (CDMA), Time division multiple access (TDMA), Global System for Mobile communications (GSM), Integrated Digital Enhanced Network (iDEN), General Packet Radio Service (GPRS), Enhanced Data rates for GSM Evolution (EDGE), Universal Mobile Telecommunications System (UMTS), Wideband Code Division Multiple Access (WCDMA), Code division multiple access 2000 (CDMA2000), Worldwide Interoperability for Microwave Access (WiMAX), Wireless-Fidelity (Wi-Fi), Long Term Evolution (LTE), and their variants. The communication device 102 may also use ad-hoc or Bluetooth connectivity to execute applications that utilize the ad-hoc or Bluetooth connection.

In one example, the communication device 102 may also be known as client device, mobile subscriber, mobile station, mobile device, and the like. The communication device 102 may be any suitable wireless communication device, including cell phone, personal digital assistant (PDA), hand-held computer, Bluetooth headset, and the like. Further, it should be understood that the present invention is not limited to a wireless communication device. Other types of wireless access terminal that includes fixed wireless terminal may be used. For a better understanding, only the term communication device is used herein and discussed hereafter. However, it should be understood that the term “communication device” in the claims and description below may include mobile wireless or wired communication devices, stationary wireless terminals (e.g., fixed wireless router) or any other electronic devices coupled to a network.

Operationally, the communication device 102 after obtaining the digital image 110 receives an indication 112 from a user. This indication 112 (as shown in FIG. 1(B)) pertains to a region 116 on the digital image 110. The region 116 as indicated covers or partially covers face of the second human 104. The communication device 102 then scans the indicated region 116 to determine an object corresponding to the indicated region of the digital image 110. In this example, the object is the face of the second human 104 captured in the digital image 110. It should be understood that the object may also correspond to facial features of the second human's face or may also correspond to other body parts of the second human 104.

The indication 112 may be a location, an area, or a trace on a display of the communication device 102. In one embodiment, the location, area, or trace may be determined using a touchscreen operated by finger, stylus, or other object. In another embodiment, the location may be determined by a touchpad, keys, or buttons. Those skilled in the art will understand various ways to use finger touches and strokes, for example, to determine the location, area, or trace.

In one embodiment, the region 116 determined from the indication 112 is a disk, oval, rectangle, or other shape of predefined size in pixels. In another embodiment, the region 116 is determined from the pixels covered by a finger as it moves on the touchscreen.

The communication device 102 after determining the object or the face of the second human 104 compares the object to a database which comprises a contacts list for the user. The contacts list may be stored locally on the communication device 102 or may be stored remotely on a server. In any case, the communication device 102 compares the object to a plurality of objects that are stored in the database and identifies a match between a stored object and the scanned object. The comparison results in the identification of a recipient for the digital image. When a match is found, contact details extracted from the database are optionally displayed to the user and the digital image 110 or a modified digital image is forwarded to the identified recipient. In this case, the identified recipient is the second human 104 pictured in the digital image 110.

In one embodiment, the communication device 102 may receive an indication 114 pertaining to a region 117 on the digital image 110 as shown in FIG. 1(C). The communication device 102 will then scan the indicated region 117 to attempt to determine an object corresponding to a recipient of the digital image 110. In this case, the indication 114 is not received directly on the object but in a neighboring region to the object which in this example is the face of the second human 104. The communication device 102 in this case scans the region 117 corresponding to the indication 114 and fails to determine an object corresponding to a recipient of the digital image 110. Following a failure to determine an object corresponding to a recipient of the digital image in the scanned region 117, the communication device 102 scans neighboring regions of region 117, which may include, for example, the region 118, which covers or partially covers the face of the second human 104. In this example, the communication device 102 scans the region 118 to attempt to determine an object potentially corresponding to a recipient of the digital image 110. If the communication device 102 detects the object in the region 118, the detected object is then compared to a plurality of objects stored in a database. Assuming that the comparison results in a match between a stored object and the detected object, the communication device 102 sends the digital image 110 or a modified digital image to a recipient corresponding to the stored object. The communication device 102 may optionally display the contact details of the recipient before sending the digital image 110 or a modified digital image. If the communication device 102 is unable to identify any object in any neighboring region of region 117, the communication device 102 may then seek more input from the user.

In one embodiment, the region 117 determined from the indication 114 is a disk, oval, rectangle, or other shape of predefined size in pixels. In another embodiment, the region 117 is determined from the pixels covered by a finger as it moves on the screen.

In one embodiment, the neighboring regions of 117 are regions close to, adjacent to, or overlapping region 117. When there is more than one neighboring region of 117, the neighboring regions may be close to, adjacent to, or overlap each other. The neighboring regions may have the same shape or different shapes from each other and from the region 117.

In a variation, the communication device 102 after receiving the indication sends a modified digital image 110 to the recipient, where example modifications include but are not limited to cropping, enhancing, and rescaling.

In another embodiment, the digital image 110 may be stored in a database, locally or remotely, and may be downloaded onto the communication device 102 for processing. In yet another embodiment, the digital image 110 may be accessed using a web page, and an indication pertaining to at least one object is given on the webpage. In this case, a server located, locally or remotely, may then process the indication and send the digital image 110 or a modified digital image to the intended recipient.

Those skilled in the art will recognize that FIG. 1 only shows two humans in the digital image 110; however there may be more than two humans or fewer than two humans in the digital image 110. It should also be understood that the embodiments of the present invention are explained taking the reference of the second human 104, however the first human 106 may also be selected as a recipient for the digital image 110.

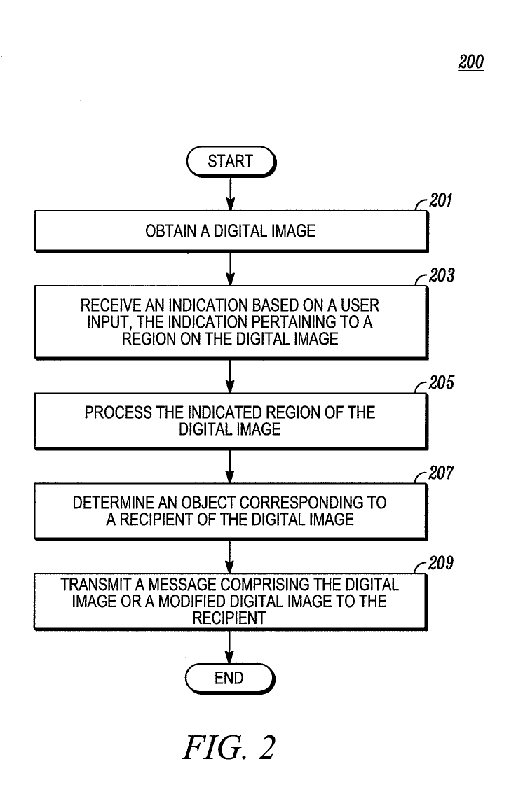

Referring now to FIG. 2, a flow diagram of an operation 200 of a communication device in accordance with some embodiments. The operation 200 of the communication device begins when the communication device obtains (201) a digital image. The digital image may be obtained from a digital camera coupled internally or externally to the communication device. The digital image may also be obtained from a server situated at a remote location. In one example, the digital image may be obtained by connecting the communication device with a personal computer. This connection can be established through a wireless connection, like Bluetooth or Infrared, or a wired connection, like a USB cable or an Ethernet cable.

After obtaining the digital image, the communication device then receives (203) an indication based on a user input. The indication pertains to a region on the digital image. The communication device may then process (205) the indicated region of the digital image to determine (207) an object corresponding to a recipient of the digital image. Once the object is determined, a message comprising the digital image or a modified digital image is transmitted (209) to the recipient. In one example, the message may be a Multimedia Messaging Service (MMS) message, or the like. In another example, the message may be an email, or the like.

The determining of an object can be performed using any method of object detection known to those skilled in the art, such as, but not limited to, template matching or the method described in “Robust Real-time Object Detection” by Paul Viola and Michael Jones, Second International Workshop on Statistical and Computational Theories of Vision—Modeling, Learning, Computing, and Sampling, Vancouver, Canada, Jul. 13, 2001.

The identification of the recipient corresponding to the detected object can be performed using any method of object recognition known to those skilled in the art, such as, but not limited to, the method described in “Face Recognition using eigenfaces” by M. A. Turk and A. P. Pentland, Proceedings of the IEEE Conference on Computer Vision and Pattern Recognition 1991, or the method described in “Face Recognition Using Laplacianfaces” by X. He et al., IEEE Transactions on Pattern Analysis and Machine Intelligence, Vol. 27, No. 3, March 2005, or the method described in “Distinctive Image Features from Scale-Invariant Keypoints” by David G. Lowe, International Journal of Computer Vision, Vol. 60, pp. 91-110, 2004.

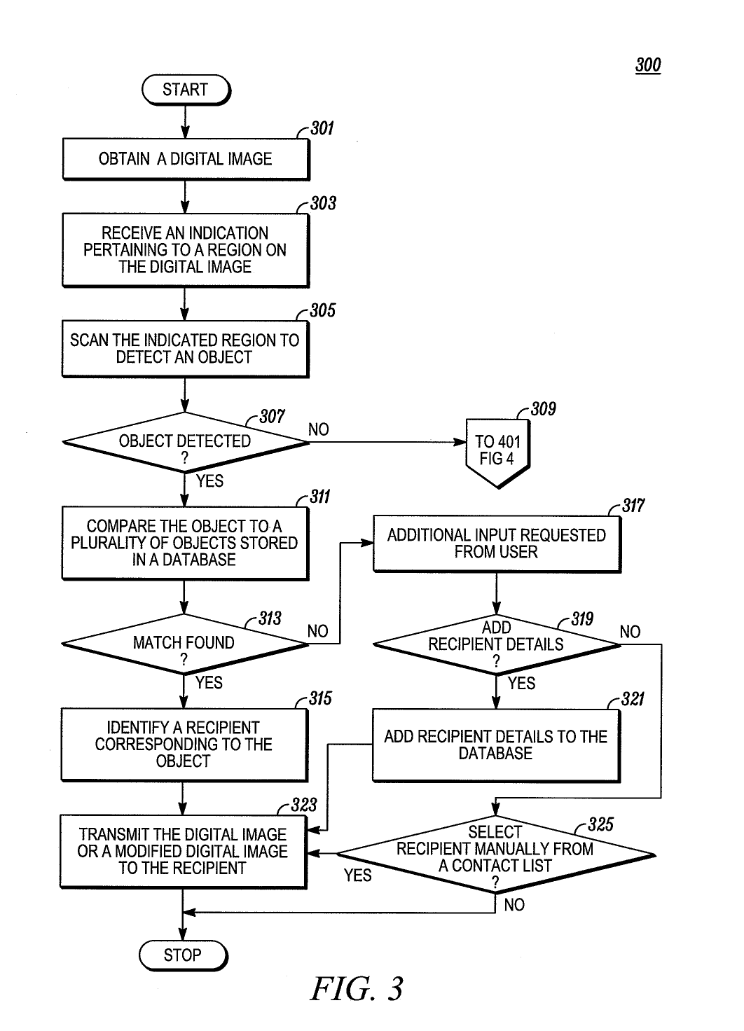

Referring now to FIG. 3, a flow diagram of an operation 300 of a communication device in accordance with some embodiments. The operation 300 of the communication device begins when the communication device obtains (301) a digital image and then receives (303) an indication pertaining to a region on the digital image. For example, the communication device may be a touch enabled communication device and the user of the touch enabled communication device may use a finger, thumb, or stylus to place an indication on the touch enabled communication device. In another example, the user may use a keypad of the communication device to place the indication. As an illustrative embodiment, the indication received is assumed to be a substantially circular indication created by the user's fingertip or thumbtip; however, other shaped indications may also be used to indicate an object on the digital image.

Returning to the operation 300, after receiving the indication, the communication device scans (305) the indicated region to detect an object. When an object is detected (307), the communication device compares (311) the object to a plurality of objects stored in a database. As mentioned earlier, the database may be located locally on the communication device itself or on a remotely located database. In one embodiment, the database may be distributed among multiple physical locations. When a match (313) between the detected object and at least one of the plurality of stored objects is found, the communication device identifies (315) a recipient corresponding to the detected object. The digital image or a modified digital image is then transmitted (323) to the recipient.

When the match is not found (313), the communication device requests (317) additional input from the user to provide the user an opportunity to add information to specify the recipient. For example, the user may add contact details of the recipient for the digital image into the database. At this point, the user decides (319) whether to add information to specify the recipient. When the user opts to add the details, the communication device adds (321) the recipient details to the database. The digital image or a modified digital image may then be transmitted (323) to the recipient. When the user opts not to add the details of the recipient, the operation 300 may end by providing options of either storing or deleting the digital image. Otherwise, the communication device may seek input from the user to select the recipient manually from a contacts list (325) and transmit the digital image or a modified digital image to the selected recipient (323).

In a variation, if a definite match is not found, then the most likely match is used. In another variation, if a definite match is not found, then a list of the most likely matches is displayed to the user and the user selects the recipient using a user interface, for example by clicking on a menu or a list.

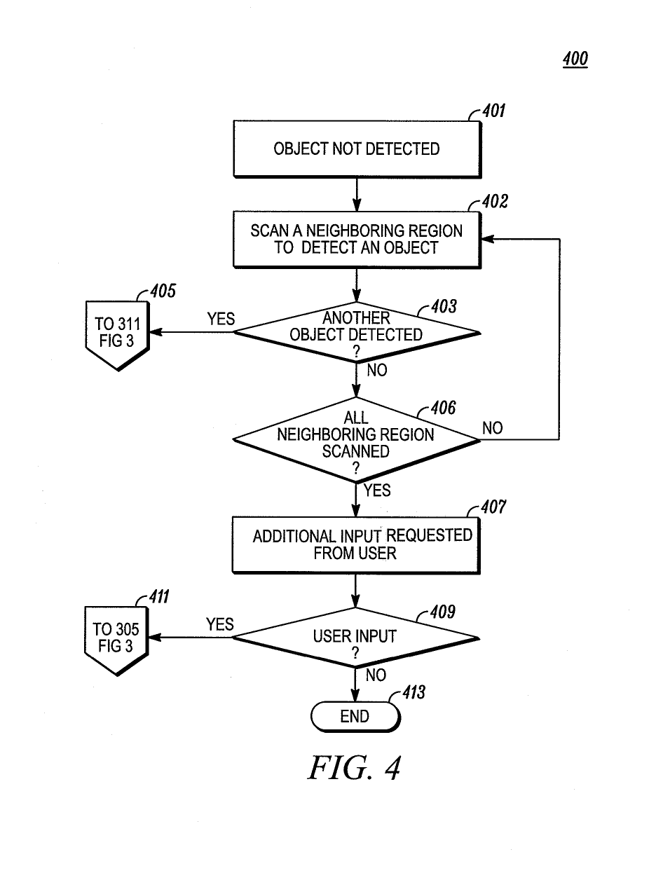

The operation 300 may move (309) to an operation 400, as illustrated by FIG. 4, when the object is not detected (307) in the indicated region. The operation 400 may begin when the object is not detected (401). The communication device scans (402) a neighboring region of the indicated region to detect another object, if any. When an object is detected (403), the operation 400 may then move (405) to operation 300, step 311 of FIG. 3. When the object is not detected (403), another neighboring region is scanned (402) until all neighboring regions have been scanned. When all neighboring regions have been scanned (406) the communication device requests additional input from the user (407) to provide an opportunity to the user of the communication device to indicate a region close to the object on the digital image. The communication device then determines (409) whether a new indication pertaining to the region close to an object on the digital image is received as a user input.

When the communication device receives the user input, the operation 400 moves (411) to operation 300, step 305 of FIG. 3. When no input is received from the user, the communication device ends (413) the operation 400.

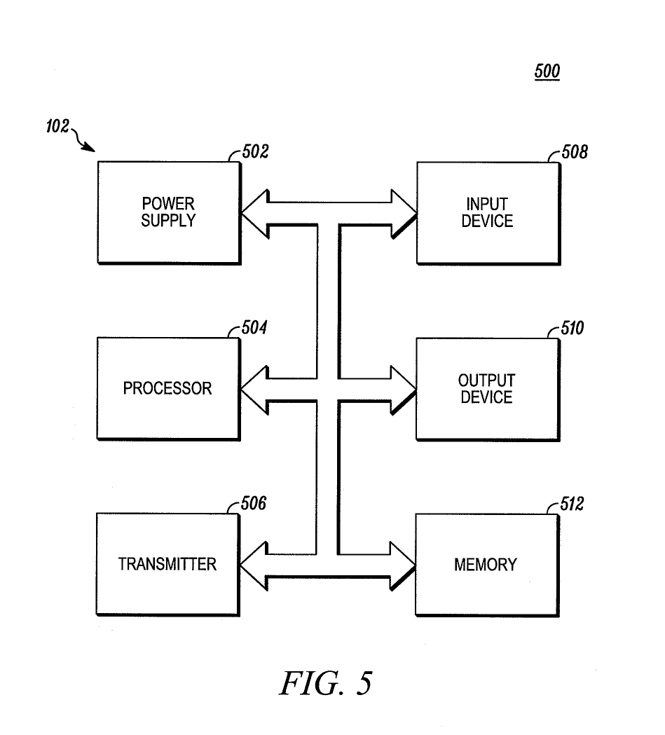

Referring now to FIG. 5, a block diagram of a communication device 102 in accordance with some embodiments for the present invention. The communication device comprises components 500 as known by those of ordinary skill such as, but not limited to, a power supply 502, an input device 508, an output device 510, a memory 512, and a transmitter 506. The communication device 102 also includes a processor 504, for implementing various embodiments of the present invention. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a program, a logic flow, a messaging/signaling flow, and/or a protocol specification, those skilled in the art are aware of the many design and development techniques available to implement a processing unit that performs the given logic. Therefore, the communication device has been adapted, in accordance with the description herein, to implement one or more than one of multiple embodiments of the present invention. Furthermore, those skilled in the art will recognize that aspects of the present invention may be implemented in and across various physical components and none are necessarily limited to single platform implementations.

Remote devices, subscriber stations (SSs) or user equipment (UEs), may be thought of as mobile stations (MSs), mobile subscriber stations (MSSs) or mobile nodes (MNs). In addition, remote device platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). Further, depending on the embodiment, the communication device may additionally comprise a keypad (not shown), a speaker (not shown), a microphone (not shown), a camera (not shown), a receiver (not shown), and/or a display (not shown). Processing units, transmitters, keypads, speakers, microphones, cameras, receivers, and displays as used in remote devices, network nodes, and/or content sources are all well-known in the art.

In one embodiment, the input device 508 is configured for obtaining the digital image and receiving an indication based on a user input. The indication here pertains to a region on the digital image. For example, the input device 508 may be a touch enabled display screen. The user in this case may then provide an indication on the display screen using a thumb, a finger, or a stylus. The processor 504, in accordance with the embodiments of the present invention, is configured to process the indicated region of the digital image to determine an object corresponding to at least one recipient of the digital image. The processor 504 may be further configured to scan the indicated region and detect the object in the scanned region. Once detected, the processor 504 compares the detected object to a plurality of objects stored in the memory 512. After determining a match between the detected object and at least one object from the memory, the processor 504 identifies a recipient corresponding to the detected object. The transmitter 506, communicatively coupled to the processor 504, transmits a message to the identified recipient, the message including the digital image or a modified digital image.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements is not restricted to including only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, multimedia processors, graphics processing units, customized processors, and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for processing a digital image to select one or more message recipients in a communication device, the method comprising:
obtaining the digital image;
receiving an indication based on a user input, the indication pertaining to a region on the digital image;
processing the indicated region of the digital image and determining an object corresponding to at least one recipient of the digital image; and
transmitting a message to the at least one recipient corresponding to the determined object, wherein the message includes the digital image or a modified digital image.

2. The method of claim 1, wherein the indication is one of a location indication, an area indication, or a trace indication.

3. The method of claim 1, wherein processing the indicated region further comprises:
scanning the indicated region; and
detecting the object in the scanned region.

4. The method of claim 3, further comprising:
comparing the object to a plurality of objects stored in a database, subsequent to detecting the object in the scanned region;
determining a match between the object and at least one of the plurality of objects stored in the database; and
identifying the recipient corresponding to the object, subsequent to determining the match between the object and at least one of the plurality of objects.

5. The method of claim 4, further comprising:
providing an opportunity to a user of the communication device to add information to specify the recipient, subsequent to determining no match between the object and at least one of the plurality of objects stored in the database.

6. The method of claim 5, wherein the providing an opportunity to a user of the communication device to add information comprises:
providing an opportunity to a user of the communication device to add details of a new recipient, subsequent to determining no match between the object and at least one of the plurality of objects stored in the database.

7. The method of claim 5, wherein the providing an opportunity to a user of the communication device to add information comprises:
providing an opportunity to a user of the communication device to select the recipient from a contacts list, subsequent to determining no match between the object and at least one of the plurality of objects stored in the database.

8. The method of claim 3, further comprising:
scanning a neighboring region of the indicated region to detect another object closest to the indicated region, if the object is not detected in the indicated region.

9. The method of claim 8, further comprising:
comparing the object to a plurality of objects stored in a database, subsequent to detecting the object in the neighboring region;
determining a match between the object and at least one of the plurality of objects stored in the database; and
identifying the recipient corresponding to the object, subsequent to determining the match between the object and at least one of the plurality of objects.

10. The method of claim 8, further comprising:
providing an opportunity to the user of the communication device to indicate a region close to the object on the digital image if object is not detected in the neighboring region.

11. The method of claim 1, wherein obtaining the digital image further comprises:
obtaining the digital image from an input device coupled to the communication device.

12. The method of claim 1, wherein obtaining the digital image further comprises:
obtaining the digital image from a remote device communicatively coupled to the communication device.

13. The method of claim 1, wherein the indication is a substantially circular indication.

14. The method of claim 1, wherein the object corresponds to a face of the recipient.

15. A communication device for processing a digital image to select one or more message recipients, the communication device comprising:
an input device configured for:
obtaining the digital image, and
receiving an indication based on a user input, the indication pertaining to a region on the digital image;
a processor configured for:
processing the indicated region of the digital image, and
determining an object corresponding to at least one recipient of the digital image; and
a transmitter configured for transmitting a message to the recipient corresponding to the determined object, wherein the message includes the digital image or a modified digital image.

16. The communication device of claim 15, wherein the processor configured for processing the indicated region is further configured for:
scanning the indicated region; and
detecting the object in the scanned region.

17. The communication device of claim 16, wherein the processor is further configured for:
comparing the object to a plurality of objects stored in a memory, subsequent to detecting the object in the scanned region;
determining a match between the object and at least one of the plurality of objects stored in the memory; and
identifying the recipient corresponding to the object, subsequent to determining the match between the object and at least one of the plurality of objects.

18. The communication device of claim 15, wherein the indication is a substantially circular indication.

19. The communication device of claim 15, wherein the object corresponds to a face of the recipient.

20. A computer-readable storage element having computer readable code stored thereon for processing a digital image to select one or more message recipients that when executed causes a client to perform the following:
obtaining the digital image;
receiving an indication based on a user input, the indication pertaining to a region on the digital image;
processing the indicated region of the digital image to determine an object corresponding to a recipient of the digital image; and
transmitting a message to the recipient, wherein the message includes the digital image or a modified digital image.
